(19) United States
(12) Patent Application Publication
(10) Pub. No.: US 2013/0091976 A1
(43) Pub. Date: Apr. 18, 2013

(54) Cable Housing System

(71) Applicant: Lois J. Mabon, Landenberg, PA (US)

(72) Inventor: Lois J. Mabon, Landenberg, PA (US)

(21) Appl. No.: 13/439,897

(22) Filed: Apr. 5, 2012

Related U.S. Application Data
(60) Provisional application No. 61/473,350, filed on Apr. 8, 2011.

(51) Int. Cl. F16C 1/20; F16C 1/10

(52) U.S. Cl. CPC F16C 1/20; F16C 1/107
USPC 74/502.4; 74/502.5

(57) ABSTRACT

An improved system for terminating a cable housing on a Bowden cable system is provided that allows for the use on conventional end caps or ferrules while providing a wide variation of sealing and inner cable protection options.

### BACKGROUND OF THE INVENTION

1. Field of the Invention

The invention relates to mechanical actuation cables, such as Bowden-type cables used to actuate transmissions, throttles, brakes and the like on vehicles, and particularly to devices used to assist in mounting, transitioning or terminating such cables.

2. Discussion of the Related Art

Mechanical actuation cables are commonly used in a variety of applications today. For instance, it is common to use a push-pull cable to actuate transmissions, throttles, and brakes on a variety of vehicles, such as bicycles, motorcycles, cars, trucks, aircraft, etc. These cables systems are commonly referred to a “Bowden cables” and refer to any type of flexible cable used to transmit mechanical force or energy by the movement of an inner cable (most commonly a metal, such as steel or stainless steel) relative to a hollow outer cable housing. The housing is generally a composite construction, consisting of a reinforcement material, such as helical steel wire, often lined with a lubricious material such as plastic, and often provided with an outer protective sheath layer, again such as plastic.

The normal functioning of a Bowden cable is to hold the housing in a fixed position and then allow the inner cable to actuate within the housing. This is usually accomplished through the use of one or more “cable stops” that hold the housing in place but allow the inner cable to move freely. Typically the cable housing will be terminated at the cable stop using an end cap or ferrule that provides a variety of benefits, including aiding in cable system assembly and installation, protecting the end of the housing (particularly against fraying and/or undesirable compression), protecting the cable stop, aiding in the transition of the inner cable, improving the aesthetics of the assembled product, and protecting users from exposed cable housing components (e.g., exposed braided reinforcement wires). With respect to systems that require very sensitive actuation, such as newer indexed bicycle shifting systems, it is imperative that there is virtually no change in cable system length over time; as such, proper cable housing termination has become even more critical for these applications.

Current cable termination caps range from simple nose-less ferrules to more complicated “nosed” devices designed to better guide/protect the inner cable and/or attempt to keep contamination (e.g., water, dust, dirt, and other foreign matter) out of the cable system. It is known that contamination can interfere with the function of the system by increasing the friction between the cable and the internal walls of the housing. This increase in friction reduces the movement of the cable and affects the overall performance of the cable system (e.g., increasing required actuation force, or causing poor braking or inconsistent shifting when used, for instance, on a bicycle).

It is recognized, however, that simple, nose-less end caps are desirable for many applications since they are widely available and inexpensive, add minimal additional weight to the overall system, and when installed under the right operating conditions (e.g., under circumstances where contamination is not a concern and/or where there is a straight path for the inner cable to exit the cable housing and cable stop) they contribute absolutely minimal addition friction to the system. On the other hand, more exotic nosed end caps tend to be application-specific (and thus more expensive and troublesome to design, manufacture and supply), weigh slightly more than comparable nose-less caps, and can contribute unwanted friction to the overall system (i.e., running the inner cable through a end cap nose will slightly increase friction over a system where a nose is not present).

While nosed-type end caps provide some amount of protection from contamination entering through the openings of the cable cap over a standard nose-less cable cap, an additional level of protection can be provided by installing a protective liner over the exposed portions of the cable. If the cable is protected from the elements outside of the housing by being covered with a protective liner, it will not come in direct contact with the contamination (e.g., water, dust, dirt or mud) that most cables are typically exposed to and will be less likely to drag the contamination into the housing when the cable is actuated.

A problem arises for a cable manufacturer of how to provide the right combination of nose-less and nosed end caps to address all anticipated customer needs. Clearly it is desirable to supply only inexpensive nose-less end caps whenever possible, but more sophisticated nosed end caps can improve cable performance under some (but not all) demanding conditions. Today, a cable manufacturer must balance all of these factors in specifying the right mix of end caps supplied with the final product.

In the case of a Bowden cable system that includes a protective covering over the inner cable beyond the cable housing, a further challenge presented to a cable manufacturer is how to mount the protective covering to hold it in place over the exposed cable portions without modifying the design of the simple nose-less cable end cap.

### SUMMARY OF THE INVENTION

The invention is directed to various embodiments of improved covers to protect exposed portions of an inner cable in a Bowden cable system that can be easily mounted without the need for a special cap design and allows for the use of a standard cable cap for terminating cable housing.

In one embodiment of the present invention, a mounting disc is provided that comprises (1) a small diameter ring that will fit inside the cable stop and (2) a liner tube that preferably is flanged (or flared) on one end so that when inserted into the ring, the flange will hold the liner tube in place. This combination of ring and liner tube allow the protective liner or nose piece to be mounted over the exposed portions of the cable and to be installed into the cable stop without the need to use a special cable end cap (or ferrule). The mounting disc of the present invention has a variety of configurations that allow for ease of mounting and has been designed to reduce the possibility of contamination from entering into the cable system. The mounting disc is held in place with the normal compression forces that are part of the design of a Bowden cable system.

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1A is a cross-section view of a conventional nosed end cap mounted within a cable stop;

FIG. 1B is plan view of the conventional nosed end cap of FIG. 1A showing its components in exploded orientation;

FIGS. 2A, 2B and 2C are plan views of the conventional nosed end cap of FIG. 1B showing the end cap components in exploded orientation, partially assembled orientation, and fully assembled orientation, respectively;

FIG. 3 is a plan view of the fully assembled conventional nosed end cap of FIG. 2C, having an inner cable mounted therethrough and a cable housing mounted over the inner cable but shown in exploded orientation from the end cap;

FIG. 4A is a cross-section view of a first embodiment of an end cap and nose piece of the present invention mounted within a cable stop;

FIG. 4B is a plan view of the first embodiment of the present invention of FIG. 4A showing its component in exploded orientation (with mounting disc shown perpendicular to normal orientation for clarity purposes);

FIGS. 5A, 5B and 5C are plan views of the first embodiment of the present invention of FIG. 4B showing the end cap and nose piece components in exploded orientation, partially assembled orientation, and fully assembled orientation, respectively;

FIG. 6 is a plan view of the first embodiment of the present invention having an inner cable mounted therethrough, the end cap and nose piece components shown in partially exploded orientation;

FIG. 7 is a plan view of the first embodiment of the present invention having an inner cable mounted therethrough, the end cap and nose piece components shown fully assembled;

FIG. 8 is a plan view of the first embodiment of the present invention having an inner cable mounted therethrough and showing a cable housing mounted within the end cap;

FIG. 9A is a cross-section view of a second embodiment of an end cap and nose piece of the present invention mounted within a cable stop;

FIG. 9B is a plan view of the second embodiment of the present invention of FIG. 9A showing its component in exploded orientation (with mounting disc shown perpendicular to normal orientation for clarity purposes);

FIGS. 10A, 10B and 10C are plan views of the second embodiment of the present invention of FIG. 9B showing the end cap and nose piece components in exploded orientation, partially assembled orientation, and fully assembled orientation, respectively;

FIG. 11 is a plan view of the second embodiment of the present invention having an inner cable mounted therethrough, the end cap and nose piece components shown in partially exploded orientation;

FIG. 12 is a plan view of the second embodiment of the present invention having an inner cable mounted therethrough, the end cap and nose piece components shown fully assembled;

FIG. 13 is a plan view of the second embodiment of the present invention having an inner cable mounted therethrough and showing a cable housing mounted within the end cap;

FIG. 14A is a cross-section view of a third embodiment of an end cap and nose piece of the present invention mounted within a cable stop;

FIG. 14B is a plan view of the third embodiment of the present invention of FIG. 14A showing its component in exploded orientation (with mounting disc shown perpendicular to normal orientation for clarity purposes);

FIGS. 15A, 15B and 15C are plan views of the third embodiment of the present invention of FIG. 14B showing the end cap and nose piece components in exploded orientation, partially assembled orientation, and fully assembled orientation, respectively;

FIG. 16 is a plan view of the third embodiment of the present invention having an inner cable mounted therethrough, the end cap and nose piece components shown in partially exploded orientation;

FIG. 17 is a plan view of the third embodiment of the present invention having an inner cable mounted therethrough, the end cap and nose piece components shown fully assembled;

FIG. 18 is a plan view of the third embodiment of the present invention having an inner cable mounted therethrough and showing a cable housing mounted within the end cap;

FIG. 19A is a cross-section view of a fourth embodiment of an end cap and nose piece of the present invention mounted within a cable stop;

FIG. 19B is a plan view of the fourth embodiment of the present invention of FIG. 19A showing its component in exploded orientation (with mounting disc shown perpendicular to normal orientation for clarity purposes);

FIGS. 20A, 20B and 20C are plan views of the fourth embodiment of the present invention of FIG. 19B showing the end cap and nose piece components in exploded orientation, partially assembled orientation, and fully assembled orientation, respectively;

FIG. 21 is a plan view of the fourth embodiment of the present invention having an inner cable mounted therethrough, the end cap and nose piece components shown in partially exploded orientation;

FIG. 22 is a plan view of the fourth embodiment of the present invention having an inner cable mounted therethrough, the end cap and nose piece components shown fully assembled;

FIG. 23 is a plan view of the fourth embodiment of the present invention having an inner cable mounted therethrough and showing a cable housing mounted within the end cap;

FIG. 24A is a cross-section view of a fifth embodiment of an end cap and nose piece of the present invention mounted within a cable stop;

FIG. 24B is a plan view of the fifth embodiment of the present invention of FIG. 24A showing its component in exploded orientation (with mounting disc components shown perpendicular to normal orientation for clarity purposes);

FIGS. 25A, 25B and 25C are plan views of the fifth embodiment of the present invention of FIG. 24B showing the end cap and nose piece components in exploded orientation, partially assembled orientation, and fully assembled orientation, respectively;

FIG. 26 is a plan view of the fifth embodiment of the present invention having an inner cable mounted therethrough, the end cap and nose piece components shown in partially exploded orientation;

FIG. 27 is a plan view of the fifth embodiment of the present invention having an inner cable mounted therethrough, the end cap and nose piece components shown fully assembled;

FIG. 28 is a plan view of the fifth embodiment of the present invention having an inner cable mounted therethrough and showing a cable housing mounted within the end cap;

FIG. 29A is a cross-section view of a sixth embodiment of an end cap and nose piece of the present invention mounted within a cable stop, an enlarged view of threaded components shown in inset FIG. 29B;

FIG. 29C is a plan view of the sixth embodiment of the present invention of FIG. 29A showing its component in exploded orientation (with mounting disc shown perpendicular to normal orientation for clarity purposes);

FIGS. 30A, 30B and 30C are plan views of the sixth embodiment of the present invention of FIG. 29C showing the end cap and nose piece components in exploded orientation, partially assembled orientation, and fully assembled orientation, respectively;

FIG. 31 is a plan view of the sixth embodiment of the present invention having an inner cable mounted therethrough, the end cap and nose piece components shown in partially exploded orientation;

FIG. 32 is a plan view of the sixth embodiment of the present invention having an inner cable mounted therethrough, the end cap and nose piece components shown fully assembled;

FIG. 33 is a plan view of the sixth embodiment of the present invention having an inner cable mounted therethrough and showing a cable housing mounted within the end cap;

FIG. 34A is a cross-section view of a seventh embodiment of an end cap and nose piece of the present invention mounted within a cable stop;

FIG. 34B is a plan view of the seventh embodiment of the present invention of FIG. 34A showing its component in exploded orientation (with mounting disc shown perpendicular to normal orientation for clarity purposes);

FIGS. 35A, 35B and 35C are plan views of the seventh embodiment of the present invention of FIG. 34B showing the end cap and nose piece components in exploded orientation, partially assembled orientation, and fully assembled orientation, respectively;

FIG. 36 is a plan view of the seventh embodiment of the present invention having an inner cable mounted therethrough, the end cap and nose piece components shown in partially exploded orientation;

FIG. 37 is a plan view of the seventh embodiment of the present invention having an inner cable mounted therethrough, the end cap and nose piece components shown fully assembled;

FIG. 38 is a plan view of the seventh embodiment of the present invention having an inner cable mounted therethrough and showing a cable housing mounted within the end cap

FIG. 39 is a plan view of an eighth embodiment of the present invention wherein an extended nose piece is provided and the invention is shown mounted in conjunction with a Bowden cable system;

FIG. 40 is a plan view of a ninth embodiment of the present invention wherein the nose piece and end cap design illustrated in FIG. 13 is combined with a continuous liner such as that described in U.S. Pat. No. 5,353,626 to Davidson, et al.;

FIGS. 41A and 41B are perspective views of an inventive protective seal device;

FIGS. 42A, 42B, 42C, and 42D are perspective views of the protective seal device of FIGS. 41A and 41 B shown mounted between an inner cable and a continuous liner.

### DETAILED DESCRIPTION OF THE ILLUSTRATED EMBODIMENTS

The present invention employs various designs of improved covers to protect exposed portions of an inner cable in a Bowden cable system that can be easily mounted without the need for a special cap design and allows for the use of a standard cable cap for terminating cable housing.

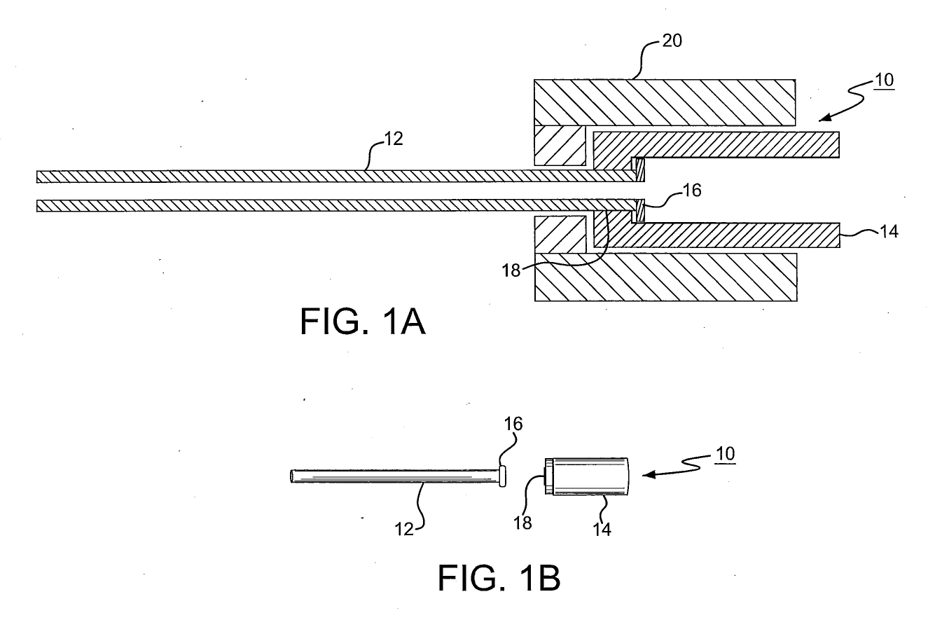

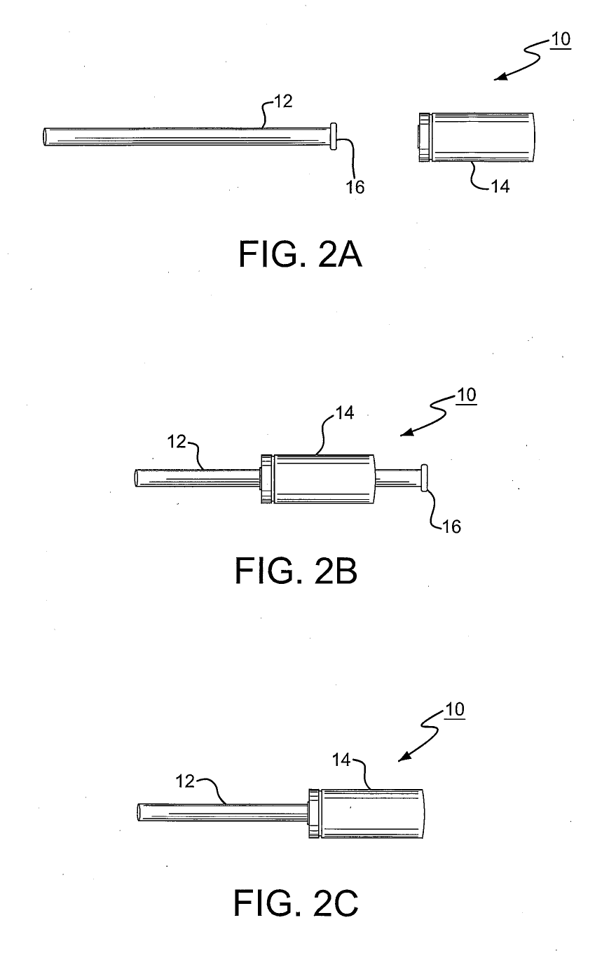

FIGS. 1A through 3 illustrate an example of a current design of a conventional nosed end cap 10 used to terminate a cable housing on a Bowden cable system. This conventional nosed end cap 10 comprises two inter-locking components: a liner tube (or protective cover or “nose”) 12; and a ferrule (or end cap) 14. The liner tube 12 includes a flanged end 16. The liner tube 12 is proportioned to fit through an opening 18 within the ferrule 14, with the flange end 16 nested within the ferrule 14 to hold the two components together, as shown in FIGS. 2A through 2C.

In use, the end cap 10 fits within a cable stop 20, such as one provided on a bicycle frame or other fixed structure, to hold a cable housing in an essentially stationary position relative to an actuating inner cable. The liner tube 12 fits past or through the cable stop 20 and helps assure that the inner cable can move freely without friction or other interference from the cable stop or contaminates that may build up around the cable stop.

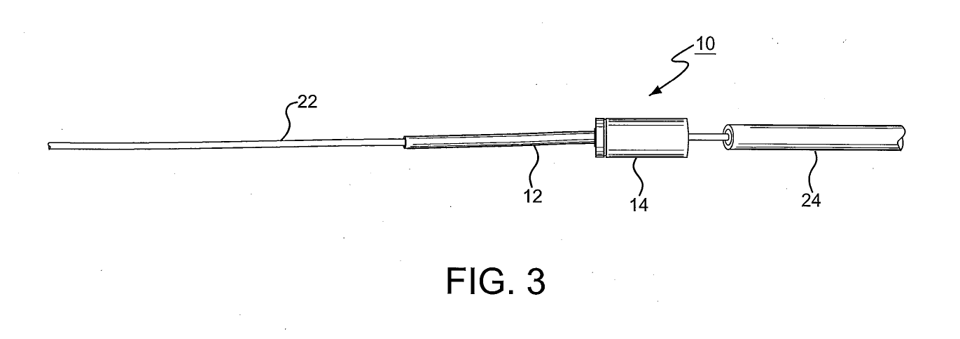

All of these components are illustrated in FIG. 3. As shown, the end cap 10 is designed to accept an inner cable 22 through its entire length, while a cable housing 24 (shown in this illustration in exploded orientation for clarity) is mounted within and protected by the ferrule component 14.

Typically these types of existing designs of end caps 10 are constructed of a relatively flexible material for the liner tube component 12, such as high-density polyethylene (HDPE), nylon, high-density polyfluoroethylene (PTFE), or the like, and a relatively stiff material for the ferrule component 14, such as a metal (e.g., aluminum or stainless steel) or relatively stiff plastic (e.g., polyamide, polyimide, etc.).

As is illustrated in the remaining figures, the present invention employs two or more separate components that function together to provide effective capping of the cable housing while also providing protection to the inner cable from wear and contamination. Each embodiment provides the option to use inexpensive standard nose-less ferrules to cap the cable housing, while allowing for the use of various inventive liner tubes to provide application-specific benefits to the overall system.

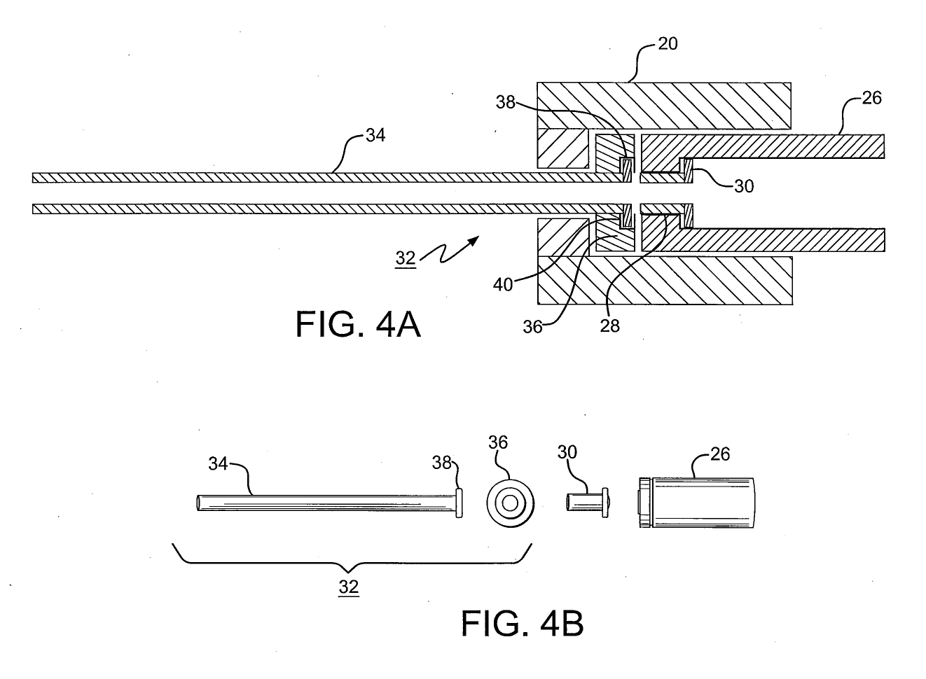

In the first embodiment of the present invention shown in FIGS. 4A and 4B, a conventional nose-less end cap (or ferrule) 26 may be employed. If fit or inner cable wear against opening 28 in the end cap 26 is a concern (e.g., to protect the inner cable from wear against an uneven surface in the opening 28), an insert 30 may optionally be provided to mount within the opening 28. A separate nose piece 32 is provided the comprises a liner tube 34 and a mounting disc 36. The liner tube 34 is provided with a flange (or flare) 38 on one end adapted to mount onto the mounting disc 36, as shown. The mounting disc 36 preferably includes an indentation or groove 40 adapted to receive the flange 38 and provided an even surface against which the end cap 26 abuts, as shown in FIG. 4A. Alternatively, the liner tube 34 and the mounting disc 36 can be constructed from a single material or joined together, such as through adhesive, welding, or other bonding means.

The liner tube 34 is preferably constructed from a resilient material, such as nylon, HDPE, PTFE, or other metal or plastic. Likewise, the mounting 36 disc may be constructed from any suitable relatively stiff material, such as DELRIN® acetal resin, aluminum, or other metal or plastic.

The nose piece 32 and end cap 26 may then be mounted within a cable stop 20 separately in an abutted orientation, as shown in FIG. 4A.

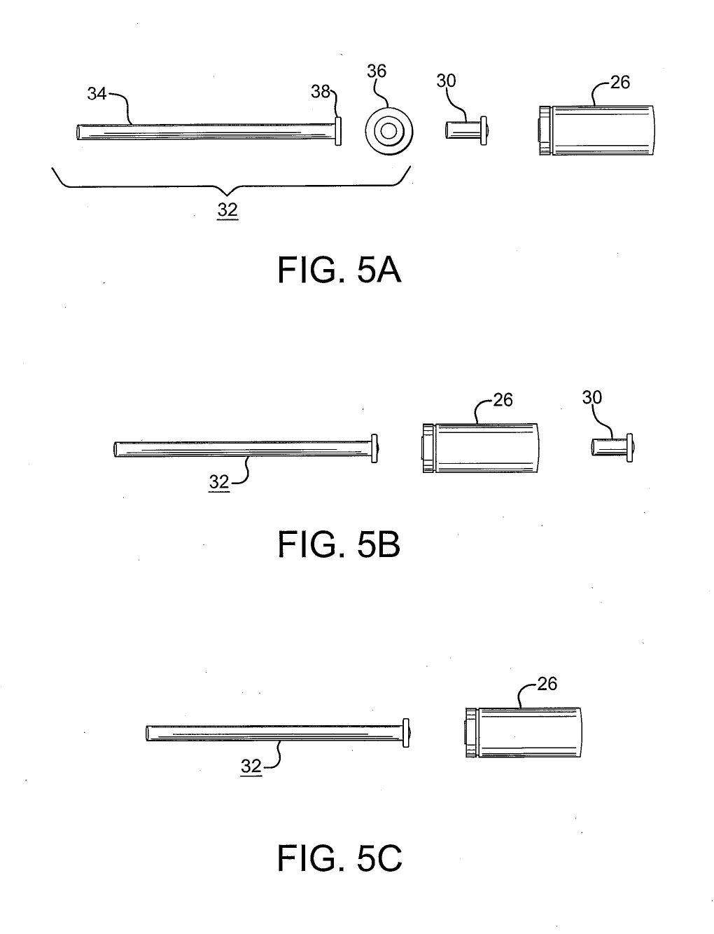

The assembly of these components are shown in FIGS. 5A through 5C.

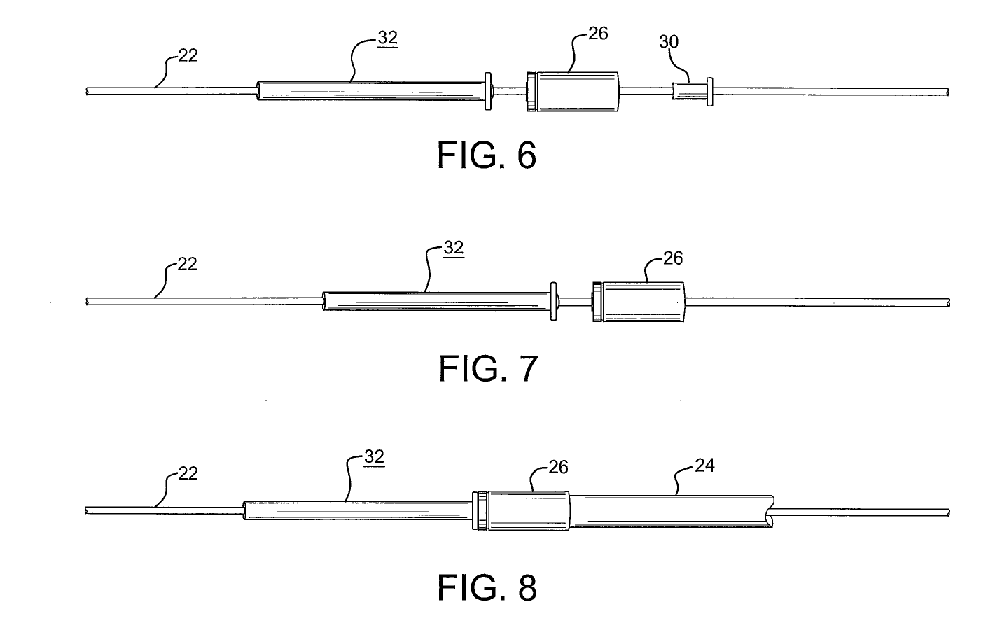

FIGS. 6 through 8 illustrate how these components are mounted relative to an inner cable 22 and a cable housing 24. As shown, the end cap 10 is designed to accept an inner cable 22 through its entire length, while a cable housing 24 (shown in this illustration in exploded orientation for clarity) is mounted within and protected by the ferrule component 14.

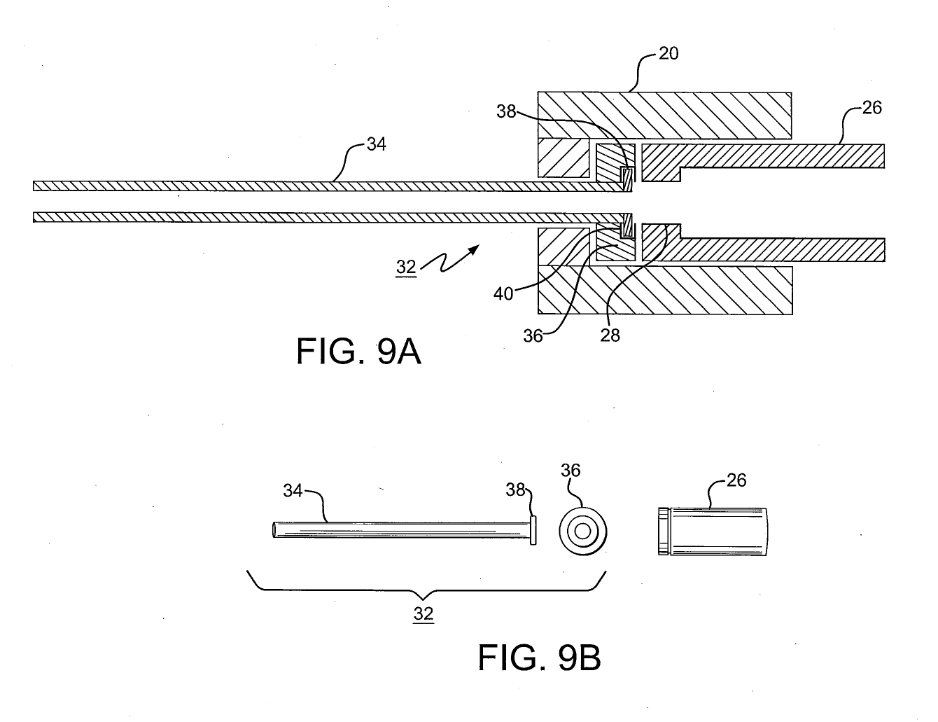

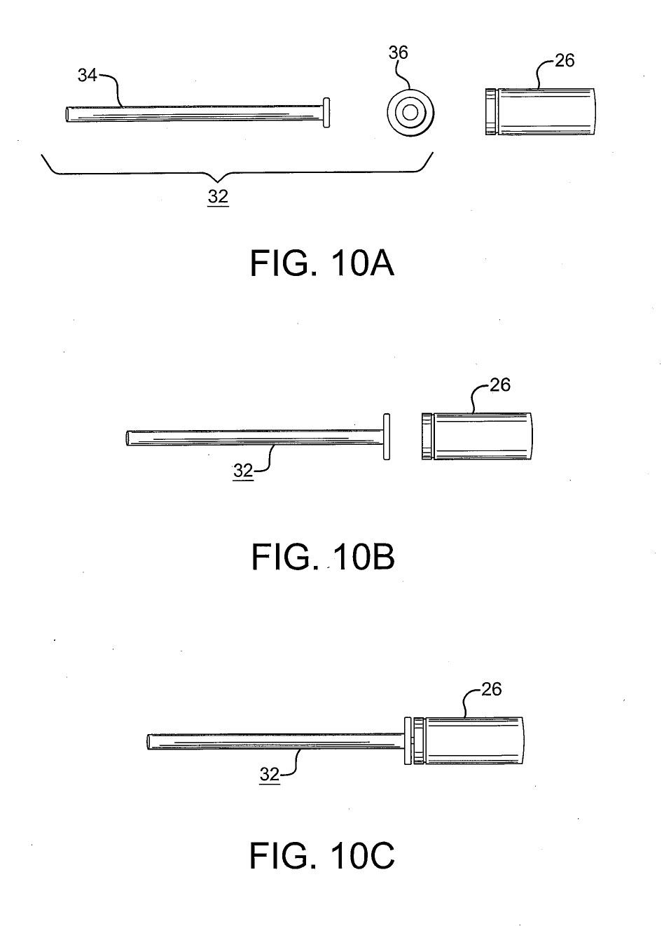

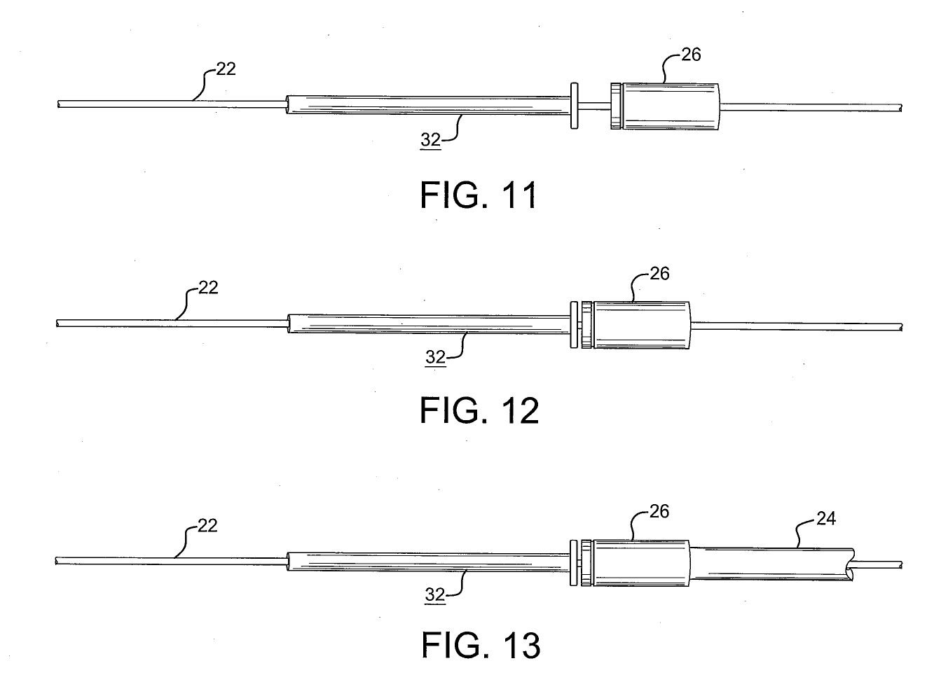

FIGS. 9A through 13 illustrate a second embodiment of the present invention, similar to the first embodiment illustrated in FIGS. 4A through 8, but employing an end cap 26 that has a sufficiently smooth opening 28 and/or is constructed from sufficiently lubricous material (e.g., polymer) that eliminates any concern about premature frictional wear of the inner cable 22 so that an insert 30 is not required. In all other respects, this embodiment is constructed and assembled in the same manner described above.

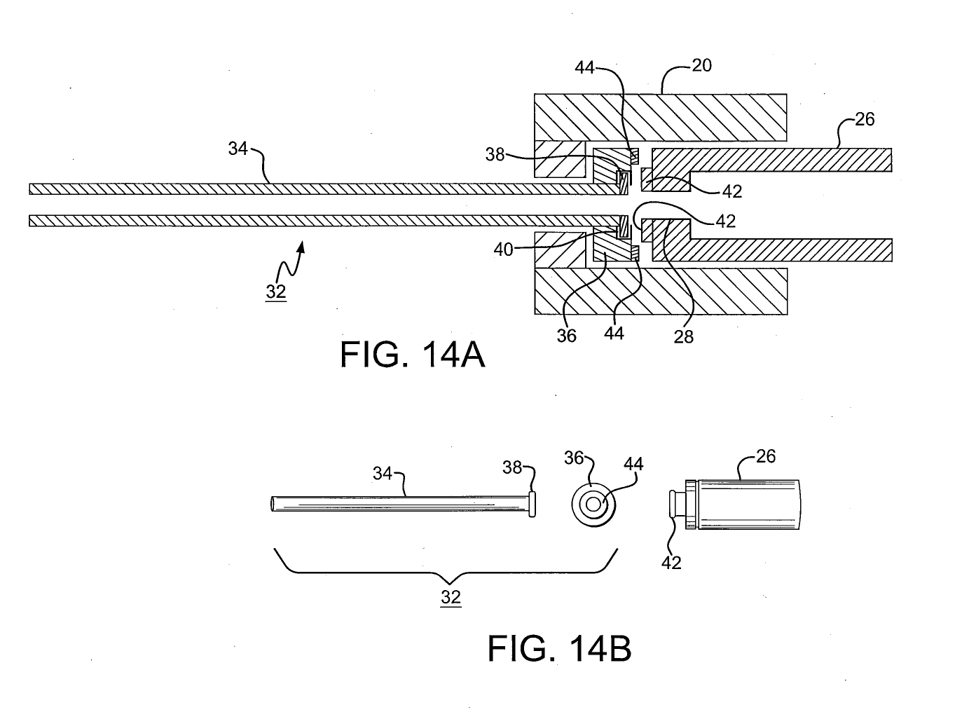

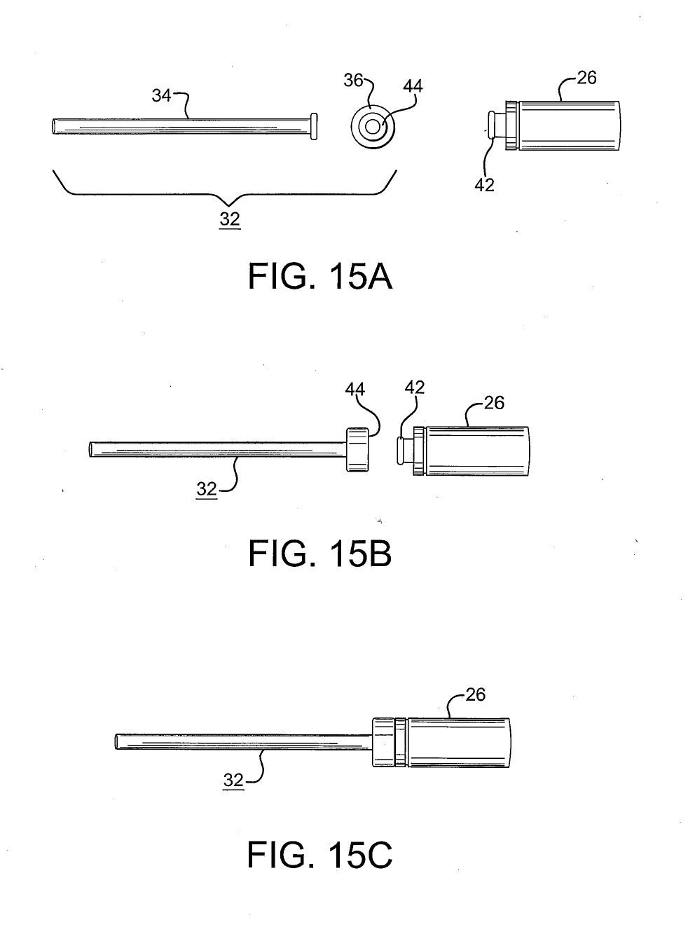

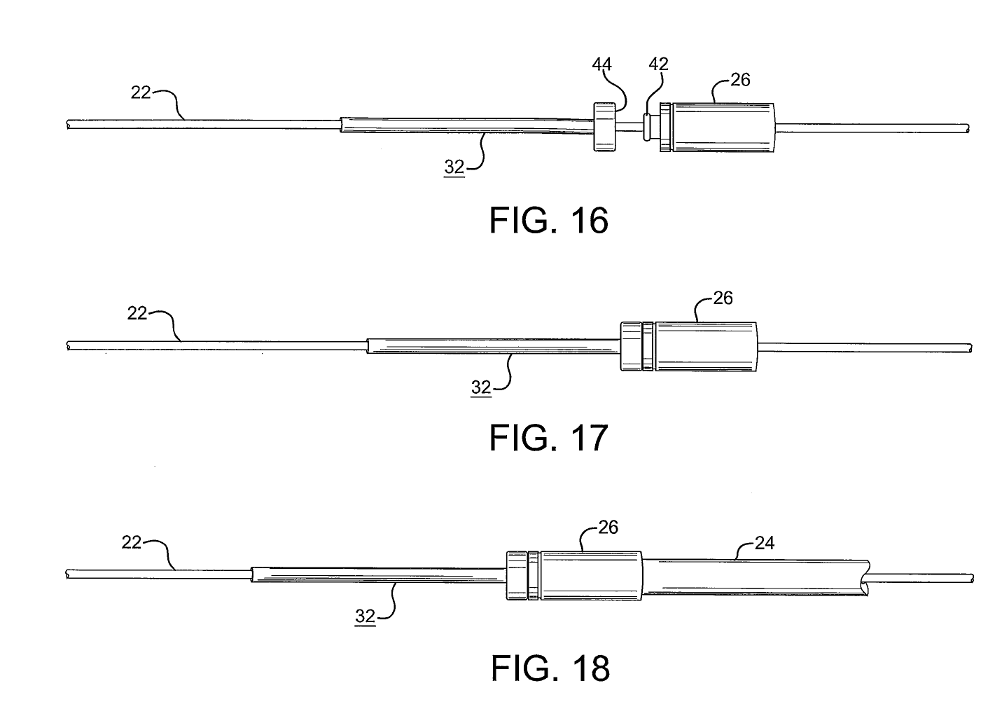

FIGS. 14A through 18 illustrate a third embodiment of the present invention in which the nose piece 32 and the end cap 26 are adapted to interlock together so as to better prevent relative movement between these two components and better exclude contaminates. In this embodiment, the end cap 26 includes a ridge or series of ridges 42 adapted to inter-cooperate with a groove or series of corresponding grooves 44 on the mounting disc 36. The ridge or ridges 42 and groove or grooves may be formed either by molding or machining from the base material and/or formed by bonding suitably shaped forms onto the end cap 26 and mounting disc 36. It should be appreciated that the ridges and grooves may be of any complementary interlocking forms, including without limitation squared or rounded projections/indentations, one or more circular or rectangular shapes, interlocking teeth, etc. It should be further understood that the ridges and grooves may be provided in the opposite fashion as that shown in FIGS. 14A through 18, whereby the ridges 42 are provided on the mounting disc 32 and the grooves are provided on the end cap 26.

In all other respects, this embodiment is constructed and assembled in the same manner described above.

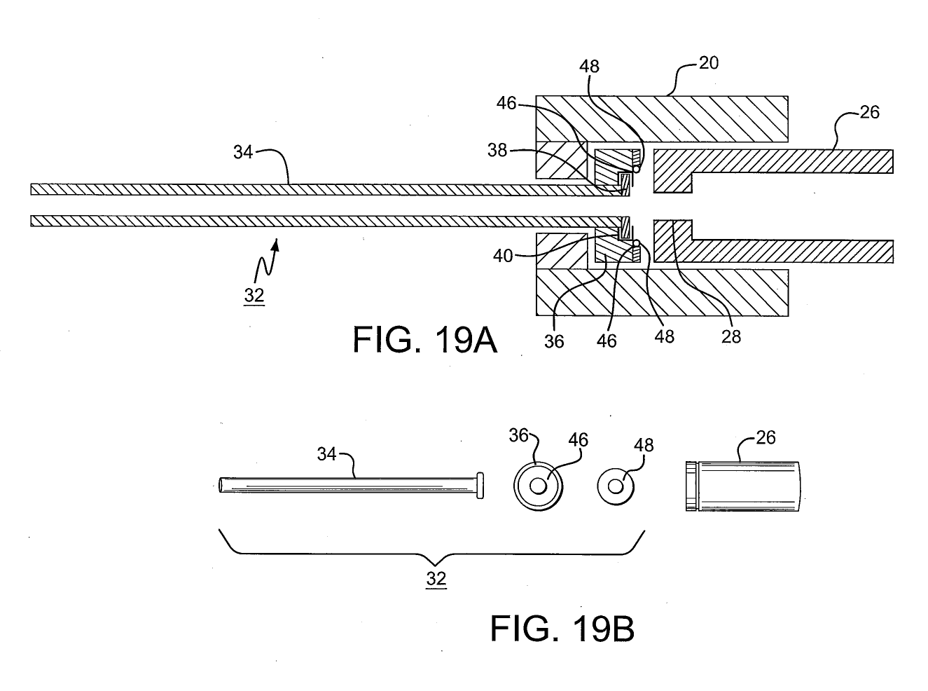

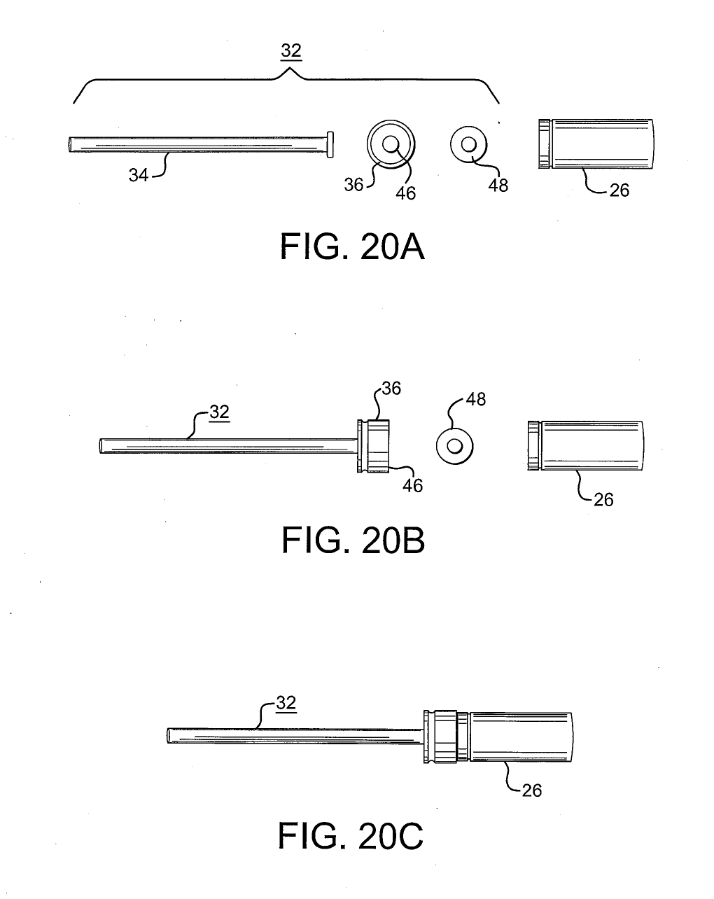

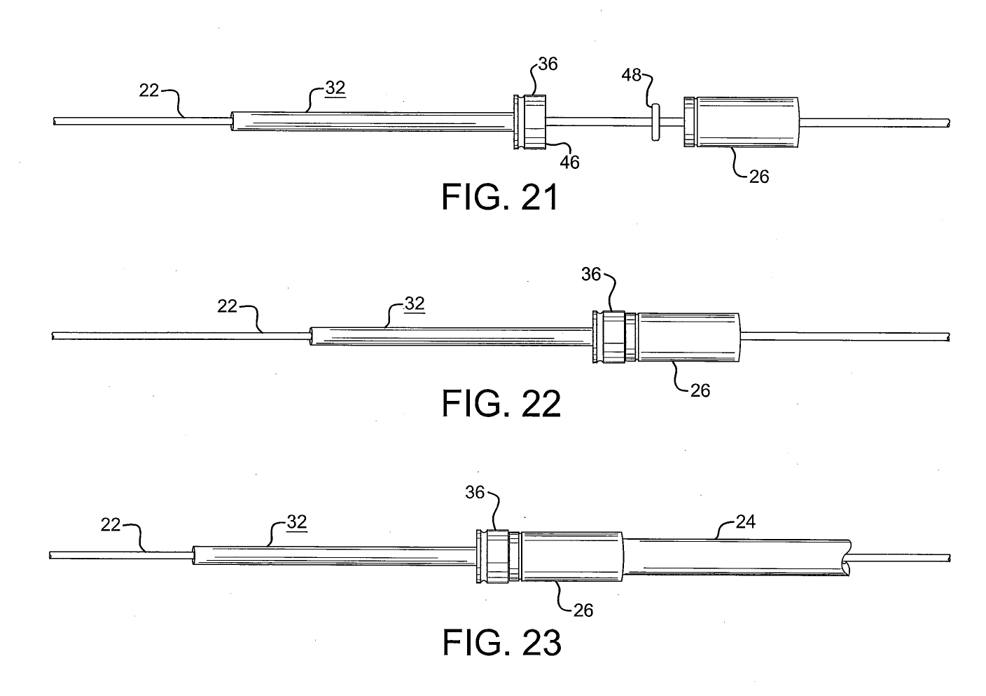

FIGS. 19A through 23 illustrate a fourth embodiment of the present invention. In this embodiment the mounting disc 36 includes a groove 46 adapted to receive a gasket 48, such as an o-ring as shown. The gasket 48 again aids in maintaining the alignment of the nose piece 32 and the end cap 26 and further assists in restricts contaminates from infiltrating the space between the two components. The exact shape and dimensions of the groove 46 and gasket 48 may be modified to address particular application-specific demands. Further, the groove 46 and gasket 48 may be alternatively or additionally provided on the end cap component 26. The gasket 48 may be formed from any suitable material, such as rubber, silicone, plastics (e.g., fluoropolymers), etc.

In all other respects, this embodiment is constructed and assembled in the same manner described above.

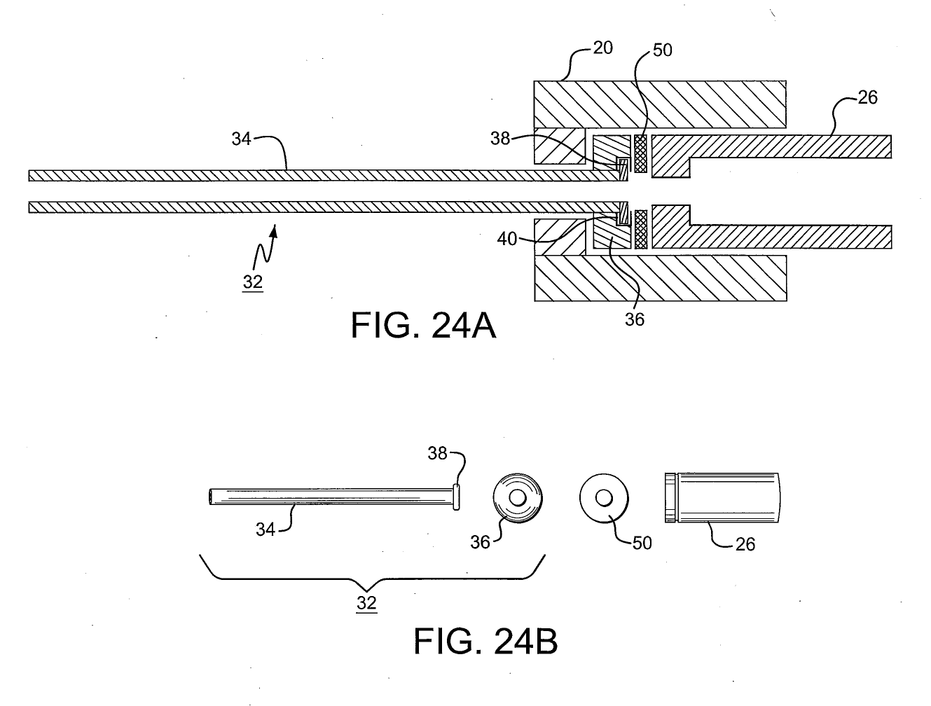

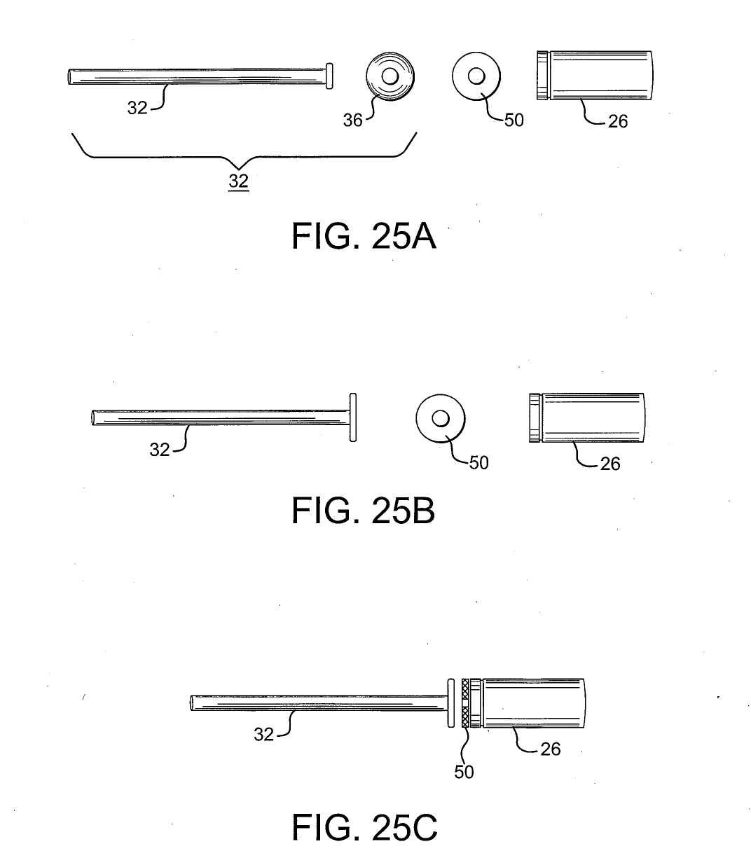

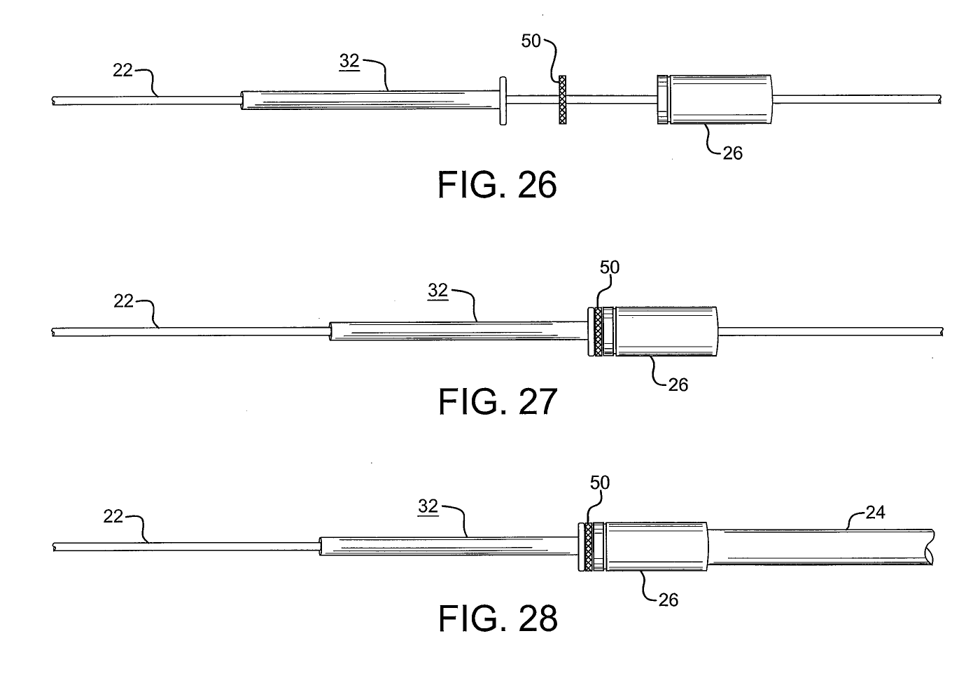

A further fifth embodiment of the present invention is illustrated in FIGS. 24A through 28. This embodiment may be employed in either of the first embodiment of FIGS. 4A through 8 or the second embodiment of FIGS. 9A through 13, or, with slight modification, in the third embodiment of FIGS. 14A through 18. In this instance a gasket component 50 is mounted between the nose piece 32 and the end cap 24 to provide improved alignment and reduced contamination between the components. All of these components are then held in place in use by the cable stop 20.

The gasket 20 may be formed from any suitable sealing material, including rubber, silicone, plastic, etc.

In all other respects, this embodiment is constructed and assembled in the same manner described above.

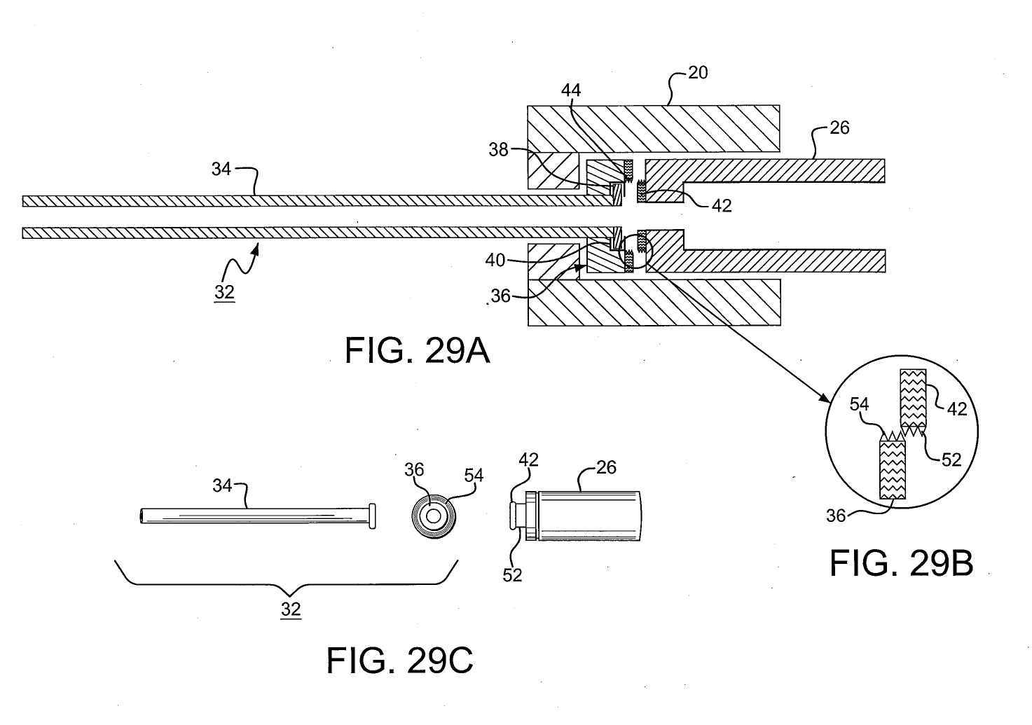

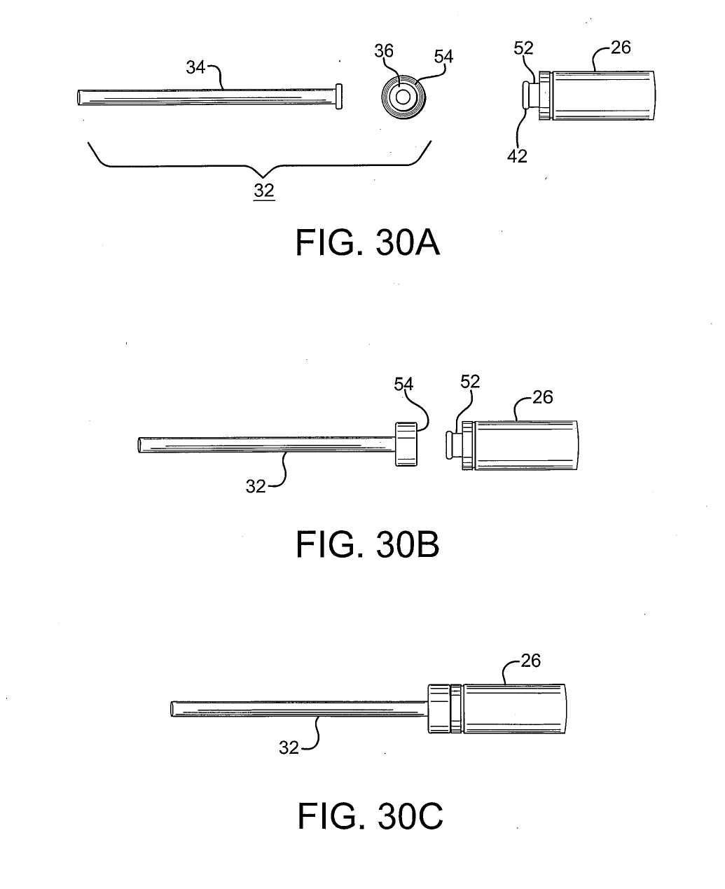

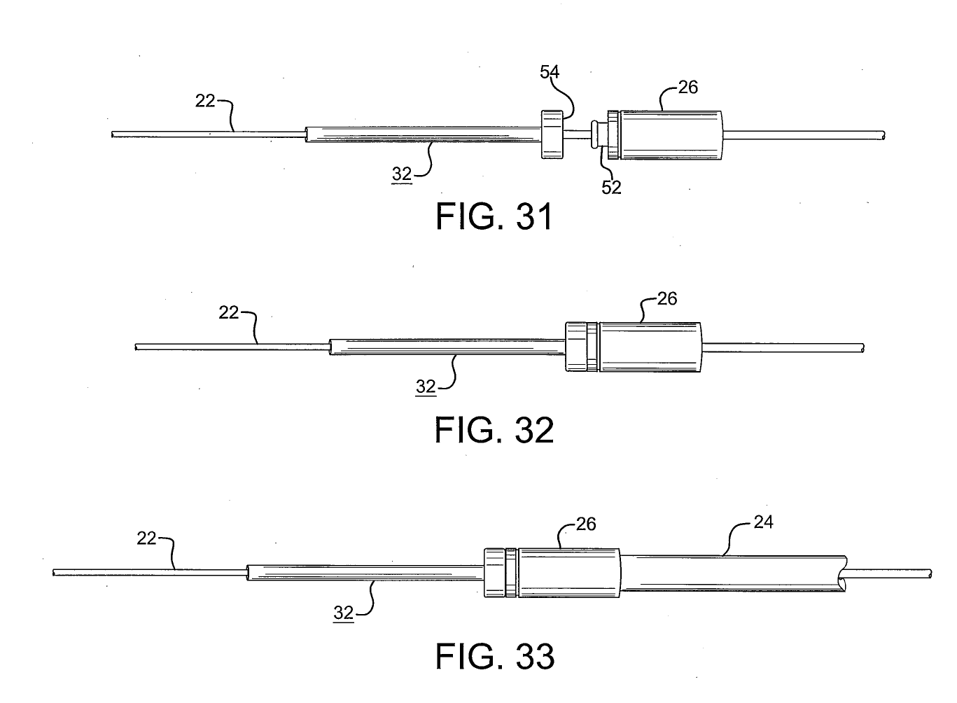

FIGS. 29A through 33 illustrate a sixth embodiment of the present invention. This embodiment is similar to the embodiment shown in FIGS. 14A through 18, but the end cap 26 and the mounting disc 36 can be more securely fastened together by providing complementary threading 52, 54 on each to allow the two components to be screwed together into a tight connection. The threading can be provided, for example, by molding and/or machining. If desired, a gasket, not shown, may be further provided between these two components to aid in their sealed connection.

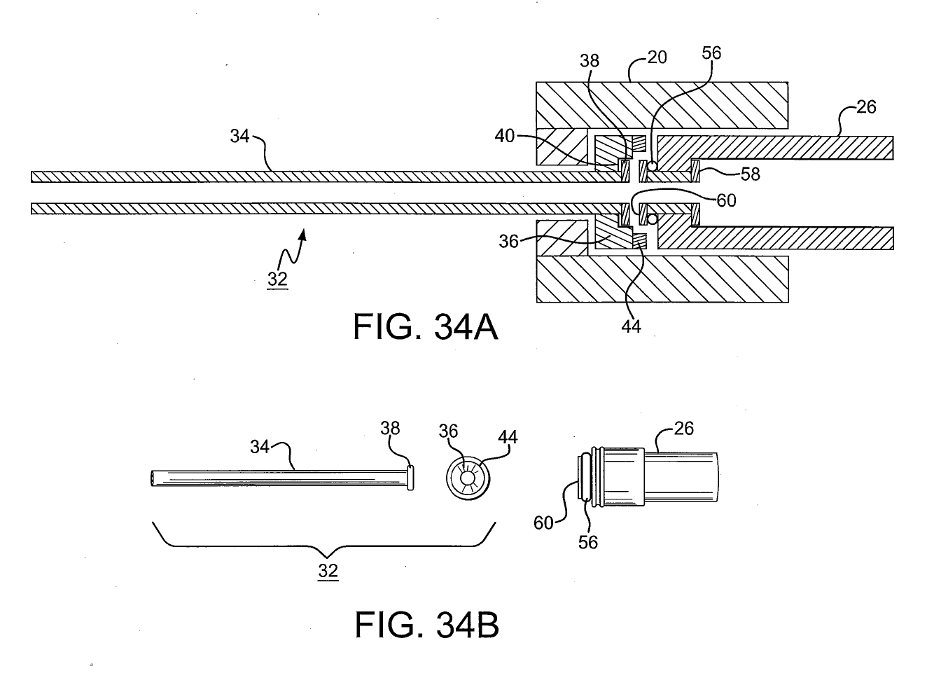

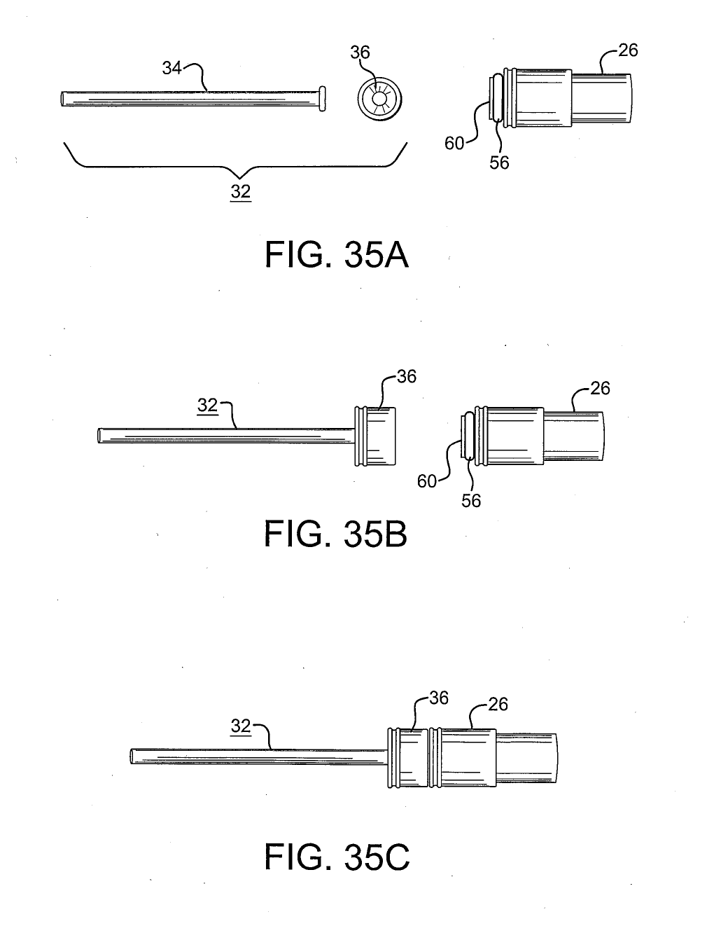

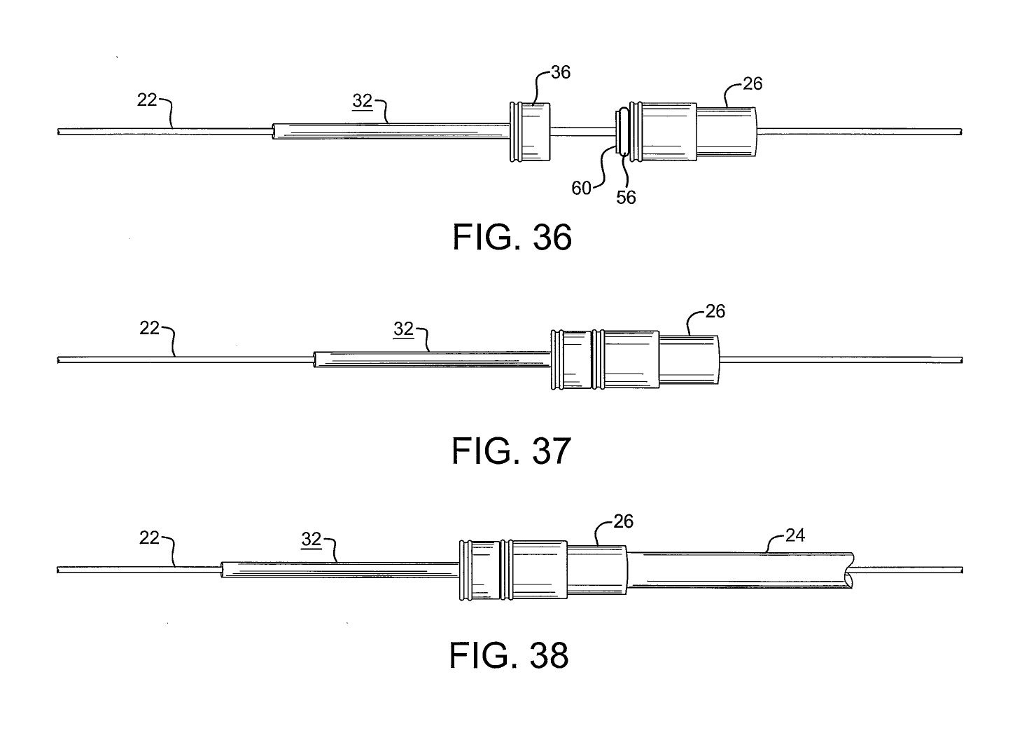

FIGS. 34A through 38 illustrate a seventh embodiment of the present invention. In this embodiment a gasket 56, such as an O-ring, is provided on a modified end cap insert 58 that includes a flange 60 to hold the gasket 56 in place. A groove 44 is provided in the mounting disc to receive the insert 58, gasket 56, and flange 60.

In all other respects, this embodiment is constructed and assembled in the same manner described above.

One benefit of the various designs of the present invention is that it allows for the easy modification of Bowden cable systems to address application-specific mounting and sealing needs. For example, it is often desirable to provide a liner tube 34 of various lengths so as to provided extended protection of the inner cable 22. The various embodiments of the present invention allows this to be readily customized by the user without the need to provided complicated modified end caps for many different possible uses.

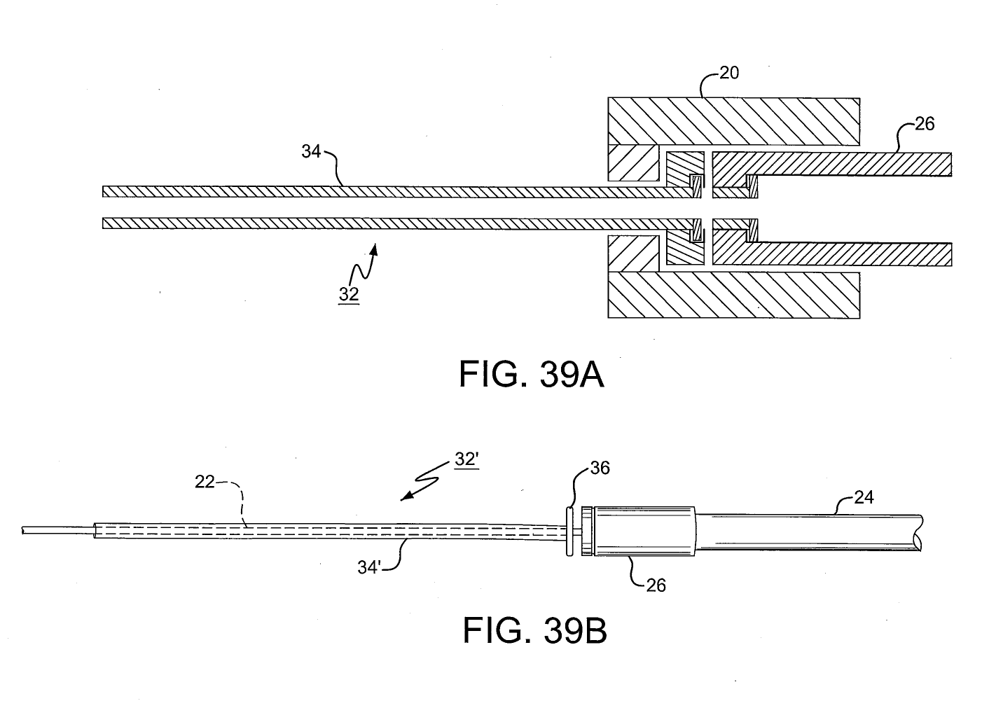

One example of this flexibility is shown in an eighth embodiment of the present invention as is illustrated in FIG. 39. In this embodiment, the inventive device as illustrated in FIGS. 4A through 8 is provided with a modified nose piece 32′ with an extended liner tube 34′ adapted to cover a long length of inner cable 22. This extended liner tube 34′ may extend the entire length of the inner cable to the next junction or component on the cable system (e.g., cable stop or device to be actuated, such as a bicycle brake or derailleur) or may terminate somewhere along the length of the inner cable.

The present invention may be further beneficial when combined with various sealed Bowden cable systems, such as that described in U.S. Pat. 5,353,626 to Davidson, et al., incorporated by reference. The liner tube 34 of the present invention may be proportioned to connect to the continuous liner, element 33, of that invention or similar constructs to provide a further improved sealed actuation system.

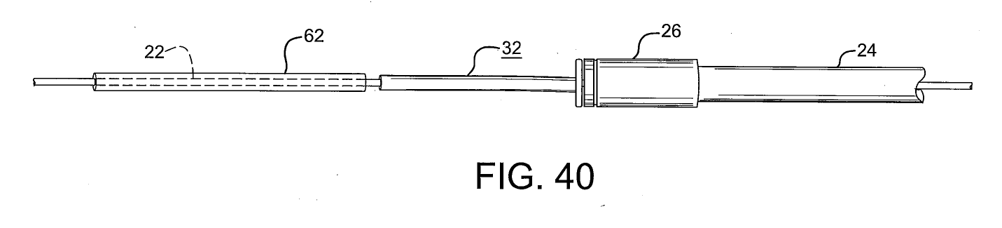

An example of this construction is shown in a ninth embodiment of the present invention as is illustrated in FIG. 40. In this embodiment the inventive device as illustrated in FIG. 13 is combined with a continuous liner 62 that is mounted over part or all of inner cable 22. This continuous liner 62 may be, for example, of the form described in U.S. Pat. No. 5,353,626 to Davidson, et al., and provides further protection from contamination and wear for the inner cable. The continuous liner 62 may be mounted to abut the noise piece 32, or may be mounted over or under the nose piece 32 to provide a better seal. Additionally, a separate seal device may be provided to cover the interface between the continuous liner 62 and the nose piece 32 to guard against infiltration of contaminates.

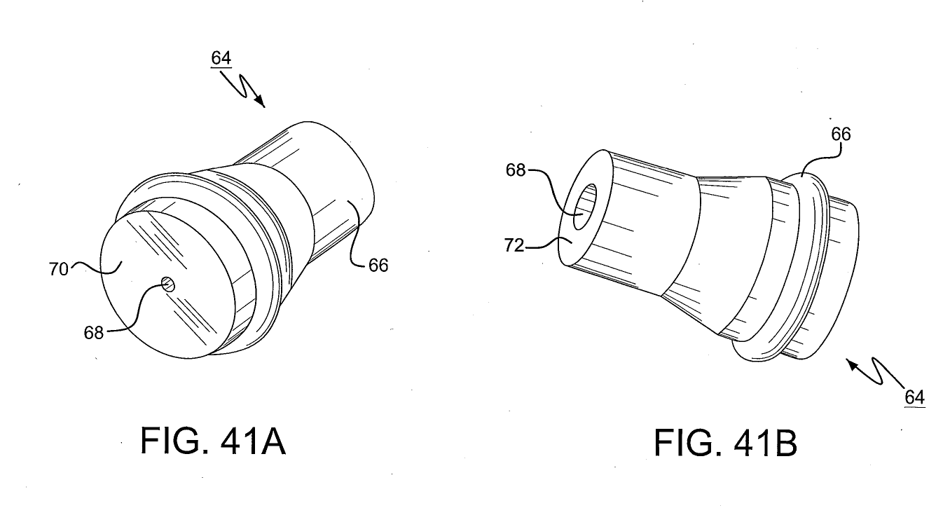

To further aid in sealing transitions in a Bowden cable system, a transition seal 64 may be provided, such as that illustrated in FIGS. 41A and 41B. The transition seal comprises a seal body 66 having a passage 68 therethrough. First end 70 is proportioned to attach to an inner cable 22, and a second end 72 adapted to attach to a nose piece 32 or continuous liner 62. The first end 70 may be adapted to be a sliding connection so not to interfere with the movement of the inner cable.

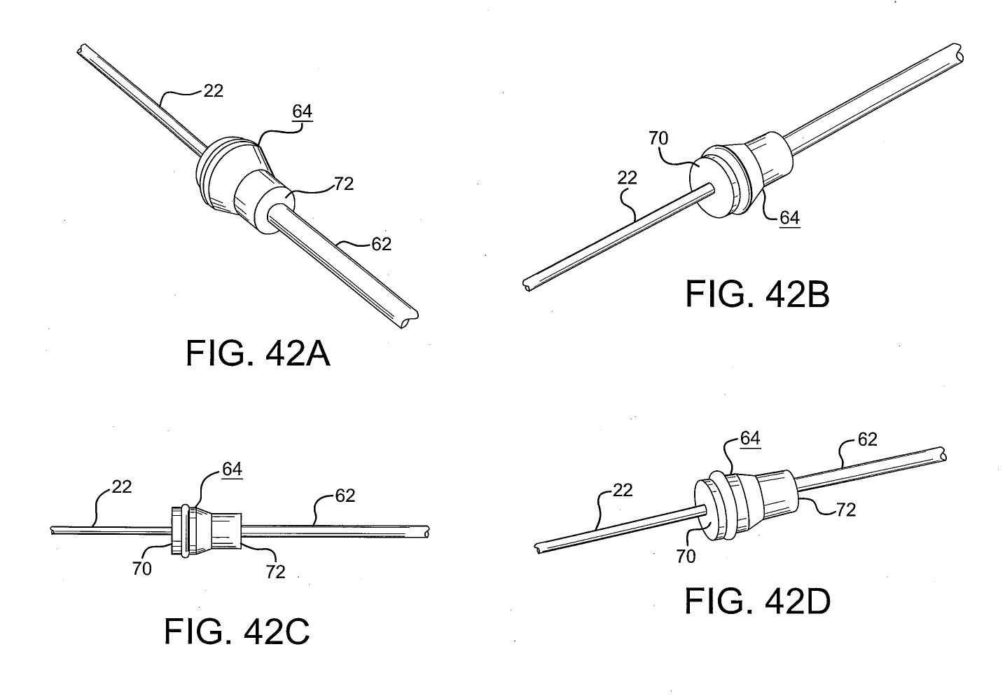

FIGS. 42A through 42D illustrated the transition seal 62 mounted between an inner cable 22 and a continuous liner 62. In this use, the transition seal 64 is provided with a first end 70 of such proportions and sufficient lubricity to allow the inner cable 22 to slide freely relative to the first end. The second end 72 is proportioned to attach securely to the continuous liner 62 so not to separate from the continuous liner 62 during use.

The transition seal 62 is preferably constructed from a durable material that is preferably somewhat resilient on its second end 72 so as to form a reliable grip to the continuous liner 62 and sufficiently lubricious on its first end 70 so not to interfere with inner cable movement during use. Suitable materials may include rubber and plastic and composites thereof, including composites incorporating silicone rubber, HDPE or PTFE.

It should be appreciated that the transition seal 64 may also be mounted in fixed relation between components that do not move relative to one another, such as sealing between the continuous liner 62 and the nose piece 32 shown in FIG. 40.

The present invention can be adapted for use in any form of Bowden cable system, including those used on bicycles, motorcycles, cars, planes, boats snowmobiles, ATV's (“4-wheelers”) and other vehicles (both recreational and non-recreational), mechanical control systems for machines, camera actuation systems, seat actuators, etc.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A Bowden cable system comprising
a cable housing;
an inner cable adapted to actuate within the cable housing;
at least one nose-less end cap adapted to mount over an end of the cable housing; and
a nose piece adapted to mount over the inner cable and between the nose-less end cap and a cable stop.

2. The Bowden cable system of claim 1 wherein the nose-less end cap comprises a standard ferrule adapted for terminating a cable housing.

3. The Bowden cable system of claim 1 wherein the nose piece comprises a protective cover and a mounting disc attached to one end of the protective cover.

4. The Bowden cable system of claim 3 wherein the mounting disc is adapted to evenly abut the nose-less end cap so as to assure smooth inner cable actuation through the end cap and the nose piece.

5. The Bowden cable system of claim 3 wherein the protective cover includes a flange on one end and the mounting disc is adapted to engage with the flange.

6. The Bowden cable system of claim 3 wherein
the mounting disc includes a ridge therein;
the nose-less end cable includes a groove therein; and
the ridge and the groove are adapted to engage with one another.

7. The Bowden cable system of claim 6 wherein the ridge and groove include interlocking components.

8. The Bowden cable system of claim 7 wherein the interlocking components comprise complementary threading on the ridge and groove.

9. The Bowden cable system of claim 1 that further includes a gasket proportioned to attached between the nose-less end cap and the nose piece.

10. The Bowden cable system of claim 9 wherein the gasket comprises an O-ring.

11. The Bowen cable system of claim 1 wherein the nose piece is adapted to connect to a protective covering for the inner cable.

12. A transition seal comprising
a seal body having a first end and a second end and a passageway communicating between the first end and the second end;
the first end being adapted to attach to an inner cable in such a manner to allow the inner cable to slide relative to the transition seal; and
the second end being adapted to attach to a covering mounted over the inner cable in such a manner so as to stay affixed to the covering.

13. The transition seal of claim 12 wherein the first end is proportioned so as to allow for relatively unimpeded movement of the inner cable.

14. The transition seal of claim 12 wherein the first end is sufficiently lubricous so as to allow relatively unimpeded movement of the inner cable.

15. The transition seal of claim 12 wherein the covering comprises a nose piece.

16. The transition seal of claim 15 wherein the covering comprises a continuous liner.
